(19) United States
(12) Patent Application Publication
(10) Pub. No.: US 2008/0189289 A1
(43) Pub. Date: Aug. 7, 2008

(54) GENERATING LOGICAL FIELDS FOR A DATA ABSTRACTION MODEL

(76) Inventors: Richard D. Dettinger, Rochester, MN (US); Frederick A. Kulack, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/671,686

(22) Filed: Feb. 6, 2007

(51) Int. Cl. G06F 17/30

(52) U.S. Cl. 707/10

(57) ABSTRACT

A method, system and article of manufacture for generating logical fields for a data abstraction model that abstractly describes physical data in a database is disclosed. A data abstraction model may define one or more dynamic entities used to generate a plurality of logical fields. Each dynamic entity may identify a field template defining a pattern for a group of logical fields. When the dynamic entity is executed, logical fields may be generated by passing parameter values to the template. The definition of a dynamic entity may also include a data request, e.g., a database query, configured to retrieve sets of parameter values for the template. In one embodiment, a dynamic entity may be configured to determine whether a given logical field is already present in the data abstraction model, before attempting to generate that logical field from the template.

### CROSS-RELATED APPLICATION

This application is related to the commonly owned U.S. Pat. No. 6,996,558, issued Feb. 7, 2006, entitled “APPLICATION PORTABILITY AND EXTENSIBILITY THROUGH DATABASE SCHEMA AND QUERY ABSTRACTION”, which is hereby incorporated herein in its entirety.

### BACKGROUND OF THE INVENTION

1. Field of the Invention

The present invention generally relates to data processing and, more particularly, to dynamically generating a collection of logical fields for a data abstraction model.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, in a DBMS, a requesting entity (e.g., an application or the operating system) demands access to a specified database by issuing a database access request. Such requests may include, for instance, simple catalog lookup requests or transactions and combinations of transactions that operate to read, change and add specified records in the database. These requests are made using high-level query languages such as the Structured Query Language (SQL) in the case of a relational database. Illustratively, SQL is used to make interactive queries for getting information from and updating a database such as International Business Machines' (IBM) DB2, Microsoft's SQL Server, and database products from Oracle, Sybase, and Computer Associates. The term “query” denominates a set of commands for retrieving physical data from a stored database. Queries take the form of a command language that lets programmers and programs select, insert, update, find out the location of physical data in a database, and so forth.

In commonly assigned U.S. patent application Ser. No. 10/083,075 (the '075 application), filed Feb. 26, 2002 entitled “APPLICATION PORTABILITY AND EXTENSIBILITY THROUGH DATABASE SCHEMA AND QUERY ABSTRACTION”, a framework was disclosed for logically viewing physical data. The framework of the '075 application provided a requesting entity (i.e., an end-user or application) with an abstract representation of physical data. In other words, the framework of the '075 application provided the requesting entity with an abstract data model that logically describes an underlying physical data structure. In this way, the requesting entity is decoupled from the underlying physical data to be accessed. Logical queries based on the framework can be constructed without regard for the makeup of the physical data. Further, changes to the physical data do not necessitate changes to applications accessing the physical data.

When using the framework of the '075 application in a database environment, physical data in an underlying database is abstractly described by logical fields that are defined by an associated abstract data model. In general, at least one logical field is created for each column in each database table in the underlying database. Further, logical fields may be part of a category. The task of creating a category from a collection of logical fields in abstract data models is typically performed by an operator or database administrator. The category structure may be hierarchical, that is, one category may include any number of sub-categories. However, for large numbers of logical fields, creating category structure manually can become an error prone and time-consuming task. Furthermore, changes and/or updates may be difficult to manage if each logical field is created individually.

One improvement to creating a category structure and logical fields for an data abstraction model is to use a template to define a pattern for a set of logical fields. The template may specify parameters used to create a set of logical fields, as well as where a logical field created using the template should be stored within the category structure. However, when multiple templates are used conflicts may occur. For example, if first template generates a particular category structure, then a second template attempting to create the same structure may fail because of the conflict.

One approach for avoiding name conflicts is to create a new category name for each template that refers to an already existing category name. For instance, assume that a template is used to define a pattern for a set of logical fields related to blood tests, where each test results in a numeric value. Assume also that a second template is used to define another pattern for a set of logical fields related to blood tests, where each test results in a list of text-strings. In such a case, a category “Blood Tests-Numeric” could be created for the first template and a “Blood Tests-Character” category could be created for the second template. Further, a third group of tests that have “present/absent” “pass/fail,” or “true/false” response could be stored in a “Blood Tests-Binary” category. In such a case, the user may have to determine which particular “blood test” category includes the desired field, forcing the user to hunt though multiple logical field categories until the desired field is found. This ad-hoc approach, however, is unsatisfactory, inefficient, and time-consuming.

Therefore, there is a need for an improved method for populating a data abstraction model exposing data stored in an underlying physical database, and in particular for techniques for generating logical fields for a data abstraction model.

### SUMMARY OF THE INVENTION

The present invention is generally directed to a method, system and article of manufacture for data processing and, more particularly, for generating logical fields for a data abstraction model that abstractly describes physical data in a database.

Embodiments of the invention includes a computer-implemented method of generating logical fields for a data abstraction model. The method generally includes retrieving, from the data abstraction model, a dynamic entity definition that identifies a logical field template used to generate a group logical fields and also retrieving one or more sets of parameter values. Each set of parameter values may be supplied to the template in order to create a logical field. The method also includes determining, for a first set of parameter values, whether a logical field to be generated from the logical field template and the first set of parameter values is present in the data abstraction model. Upon determining that the logical field to be generated from the logical field and the first set of parameter values is not present in the data abstraction model, the method also includes generating the logical field from the logical field template and the first set of parameter values and adding the generated logical field to the data abstraction model.

Another embodiment of the invention includes a computer-readable storage medium containing a program which, when executed by a processor, performs a process for generating logical fields for a data abstraction model. The process generally includes retrieving, from the data abstraction model, a dynamic entity definition that identifies a logical field template used to generate a group logical fields and also retrieving one or more sets of parameter values. Each set of parameter values may be supplied to the template in order to create a logical field. The process also includes determining, for a first set of parameter values, whether a logical field to be generated from the logical field template and the first set of parameter values is present in the data abstraction model. Upon determining that the logical field to be generated from the logical field and the first set of parameter values is not present in the data abstraction model, the process also includes generating the logical field from the logical field template and the first set of parameter values and adding the generated logical field to the data abstraction model.

Another embodiment of the invention includes a system having a processor and a memory. The memory contains a program which, when executed by the processor is generally configured to retrieve, from the data abstraction model, a dynamic entity definition that identifies a logical field template used to generate a group logical fields and also to retrieve one or more sets of parameter values. Each set of parameter values may be supplied to the template in order to create a logical field. The program is further configured to determine, for a first set of parameter values, whether a logical field to be generated from the logical field template and the first set of parameter values is present in the data abstraction model. Upon determining that the logical field to be generated from the logical field and the first set of parameter values is not present in the data abstraction model, the program is configured to generate the logical field from the logical field template and the first set of parameter values and to add the generated logical field to the data abstraction model.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a computer system that may be used in accordance with the invention;

FIG. 2 is a relational view of software components used to create and execute database queries and to generate required logical fields for a data abstraction model dynamically, according to one embodiment of the invention;

FIGS. 3A-C are relational views of software components in one embodiment;

FIGS. 4-5 are flow charts illustrating the operation of a runtime component, in one embodiment;

FIG. 6 is a flow diagram illustrating a method for generating a collection of logical fields using a dynamic entity, according to one embodiment of the invention; and

FIG. 7 is a relational view illustrating generation of logical fields for a data abstraction model that abstractly describes physical data in a database in one embodiment.

### DETAILED DESCRIPTION OF THE PREFERRED EMBODIMENTS

### Introduction

The present invention is generally directed to a method, system and article of manufacture for data processing and, more particularly, for generating logical fields for a data abstraction model used to abstractly describe data in an underlying database. In general, the data abstraction model exposes data in the underlying database using a collection of logical fields, making the schema of the physical data transparent to users. Furthermore, the logical fields may be organized and stored using a hierarchal category structure.

In one embodiment, a dynamic entity may use a logical field template to generate a set of categories and/or logical fields at runtime. The definition of a dynamic entity may also include a data request (e.g., a database query) used at runtime to retrieve sets of parameter values supplied to the template. In one embodiment, a dynamic entity may be configured to generate logical field categories in the data abstraction model used to store logical fields created using that entity. Further, in the event that a given logical field category already exists in the category structure, rather than fail the logical field creation process, the dynamic entity may be configured to create and store additional logical fields in the existing category. Thus, attempts to re-create an existing category or field may effectively be ignored to prevent errors which might otherwise result in process interruption and/or program abort.

To this end, when a dynamic entity is executed, prior to creating a category and/or logical field, a determination is made whether such field or category already exist within a given data abstraction model. If neither the category nor the field exists, both are created using the field template specified by the dynamic entity. Otherwise, if the category already exists, a logical field may be generated within the already existing category. If, however, both the logical field and category already exist, processing of the given set of parameter values is terminated and another set of parameter values, if available, is processed.

### PREFERRED EMBODIMENTS

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

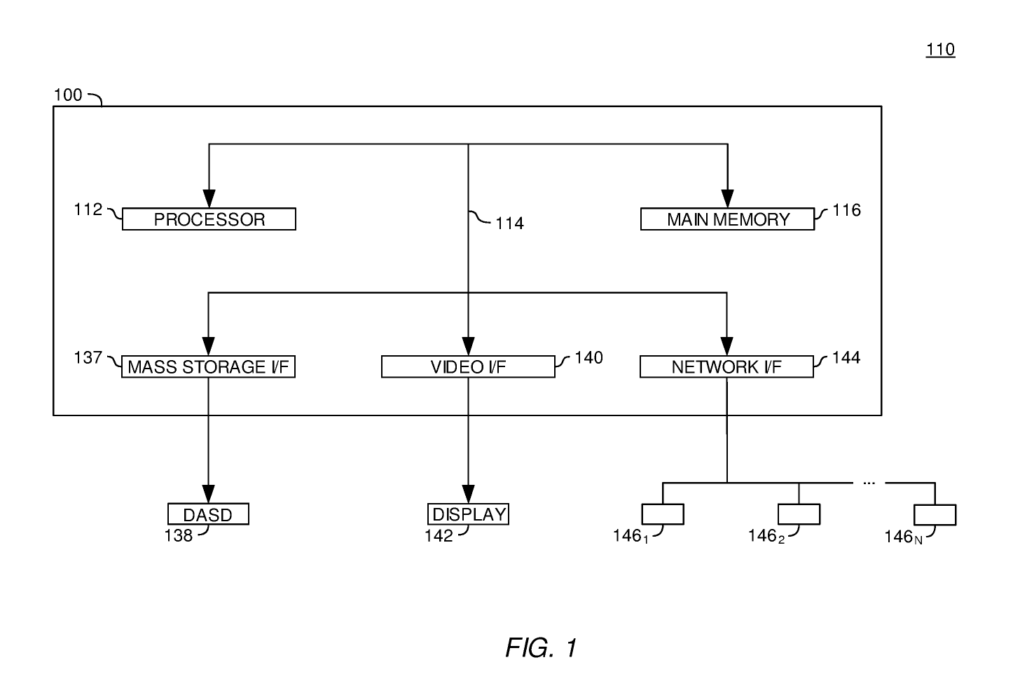

One embodiment of the invention is implemented as a program product for use with a computer system such as, for example, computer system 110 shown in FIG. 1 and described below. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Computing Environment

FIG. 1 shows a computer 100 (which is part of a computer system 110) that becomes a special-purpose computer according to an embodiment of the invention when configured with the features and functionality described herein. The computer 100 may represent any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention. Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention may be adapted for use with other configurations, regardless of whether the computer 100 is a complicated multi-user apparatus, a single-user workstation, or a network appliance that does not have non-volatile storage of its own.

The computer 100 could include a number of operators and peripheral systems as shown, for example, by a mass storage interface 137 operably connected to a storage device 138, by a video interface 140 operably connected to a display 142, and by a network interface 144 operably connected to a plurality of networked devices 146 (which may be representative of the Internet) via a network. Although storage 138 is shown as a single unit, it could be any combination of fixed and/or removable storage devices, such as fixed disc drives, floppy disc drives, tape drives, removable memory cards, or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention.

The main memory 116 is any memory sufficiently large to hold the necessary programs and data structures. Main memory 116 could be one or a combination of memory devices, including Random Access Memory, nonvolatile or backup memory, (e.g., programmable or flash memory, read-only memory, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer 100 via bus 114. Thus, main memory 116 and storage device 138 could be part of one virtual address space spanning multiple primary and secondary storage devices.

### An Exemplary Query Creation and Execution Environment

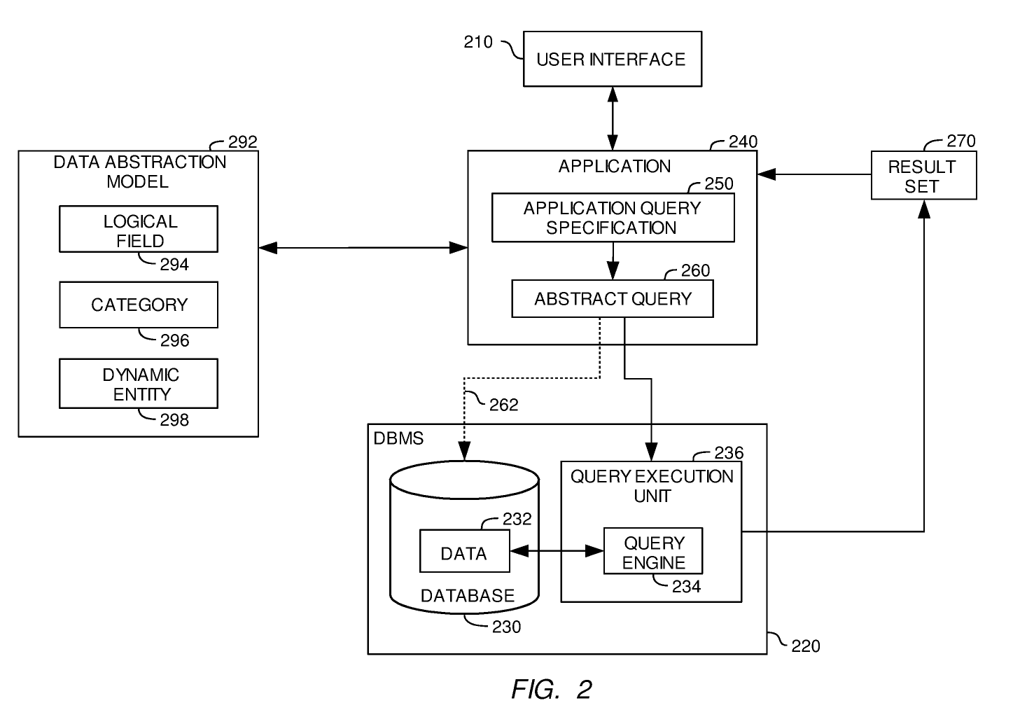

FIG. 2 illustrates a relational view of software components configured according to one embodiment of the invention. As shown, the software components include a user interface 210, a DBMS 220, one or more applications 240 (only one application is illustrated for simplicity) and one or more data abstraction models 292 (only one data abstraction model is illustrated for simplicity). The DBMS 220 illustratively includes a database 230 and a query execution unit 236 having a query engine 234.

The database 230 is shown as a single database having data 232. However, the database 230 may also be implemented by multiple databases distributed relative to one another. Moreover, one or more databases can be distributed relative to one or more networked devices (e.g., networked devices 146 of FIG. 1). The database 230 is representative of any collection of data regardless of the particular physical representation of the data. A physical representation of data defines an organizational schema of the data. By way of illustration, the database 230 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of the data 232.

According to one aspect, the application 240 (and more generally, any requesting entity including, at the highest level, users) issues queries to retrieve data 232 from database 230. In general, queries issued by application 240 are defined according to an application query specification 250 and may be predefined (i.e., hard coded as part of the application 240) or generated in response to input (e.g., user input). Queries issued by the application 240 may be generated by users interacting with a user interface 210, which provides an user interface create/submit queries. According to one aspect, the user interface 210 is a graphical user interface. However, it should be noted that the user interface 210 is only shown by way of example. And any suitable requesting entity may create and submit queries processed by database 230 (e.g., the application 240, an operating system or an end user).

In one embodiment, application 240 and/or query execution unit 236 may communicate with a database connectivity tool such as a Web application, an Open DataBase Connectivity (ODBC) driver, a Java® DataBase Connectivity (JDBC) to submit queries for processing. A Web application is an application that is accessible by a Web browser and that provides some function beyond static display of information, for instance by allowing a user to compose and submit a query processed by database 230. An ODBC driver is a driver that provides a set of standard application programming interfaces to perform database functions such as connecting to the database 230, performing dynamic SQL functions, and committing or rolling back database transactions. A JDBC driver is a program included with a database management system (e.g., DBMS 220) to support JDBC standard access between the database 230 and Java® applications.

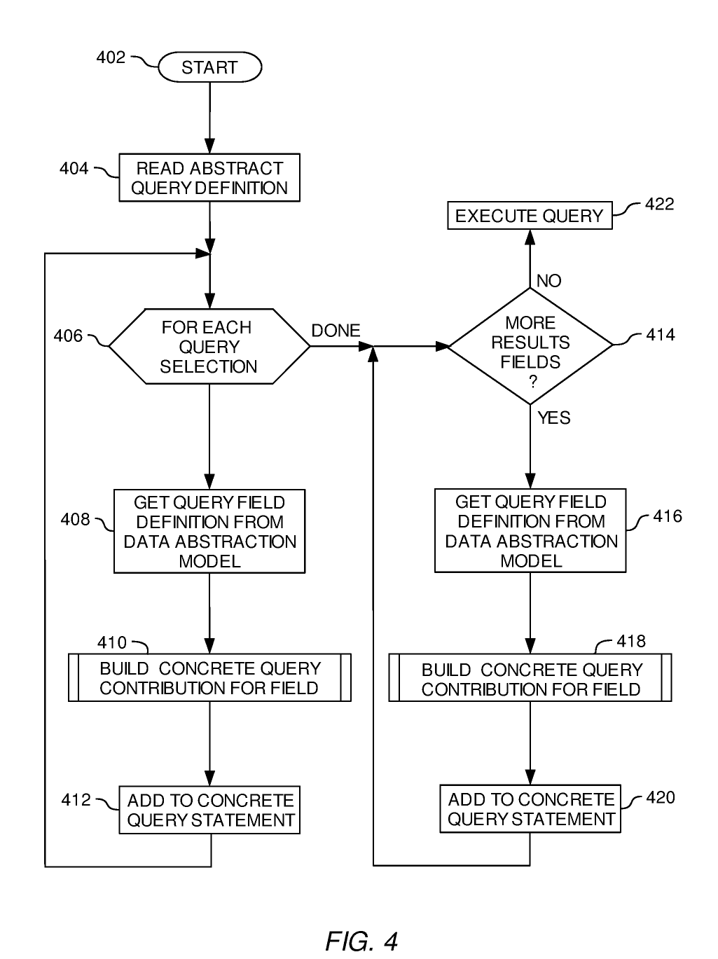

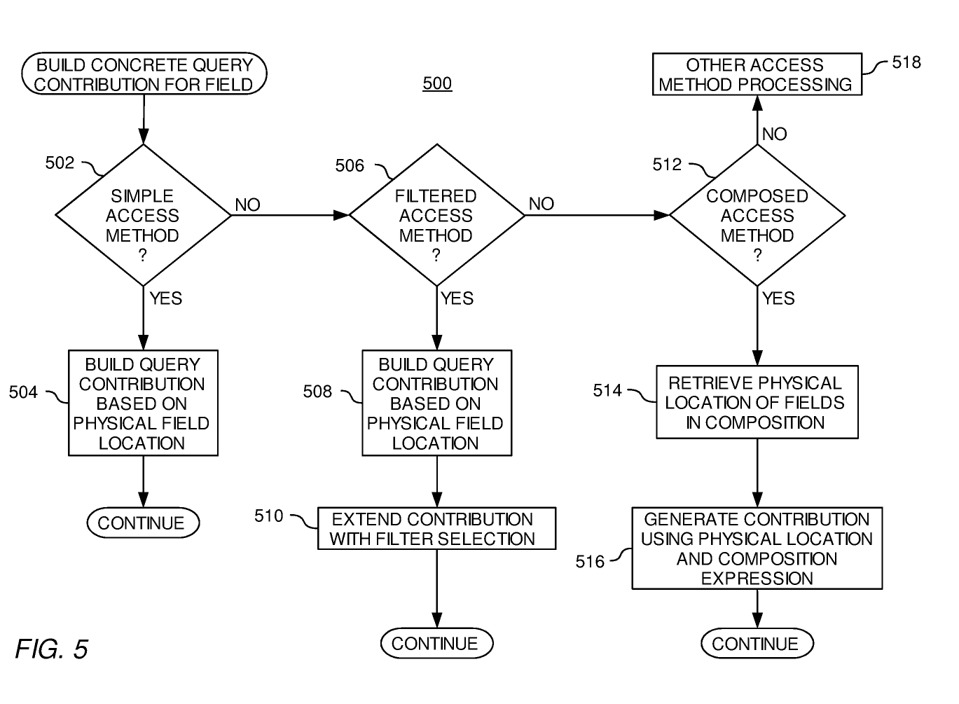

In one embodiment, the queries issued by the application 240 are composed using logical fields 294 provided by data abstraction model 292. Such queries are referred to herein as “abstract queries.” The abstract queries are transformed into a form consistent with the physical representation of the data 232 and executed by query execution unit 236 against database 230. Transformation of an abstract query into an executable query is described in more detail below with reference to FIGS. 4-5.

As shown in FIG. 2, an abstract query 260 is created using logical fields provided by the data abstraction model 292 and evaluated using data 232, (as illustrated by a dashed arrow 262). By way of example, the data abstraction model 292 defines multiple logical fields 294 (only one logical field is illustrated for simplicity). Furthermore, logical fields 294 may be stored in a set of categories 296, such as a hierarchy of categories and fields from which users may compose an abstract query.

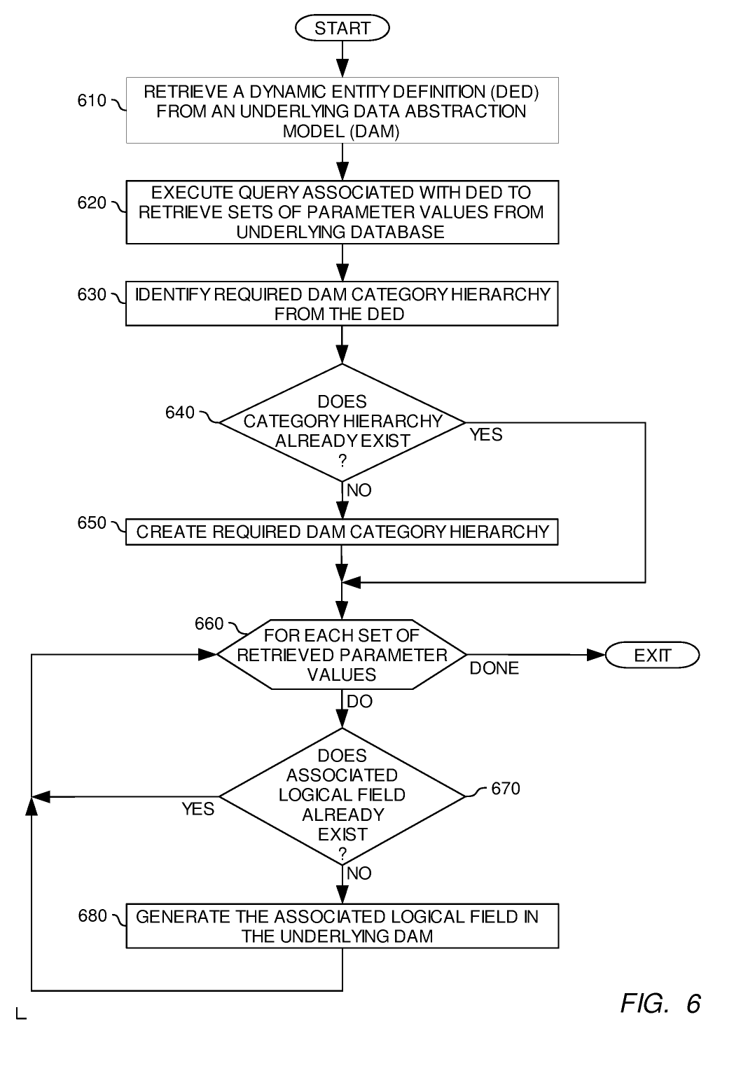

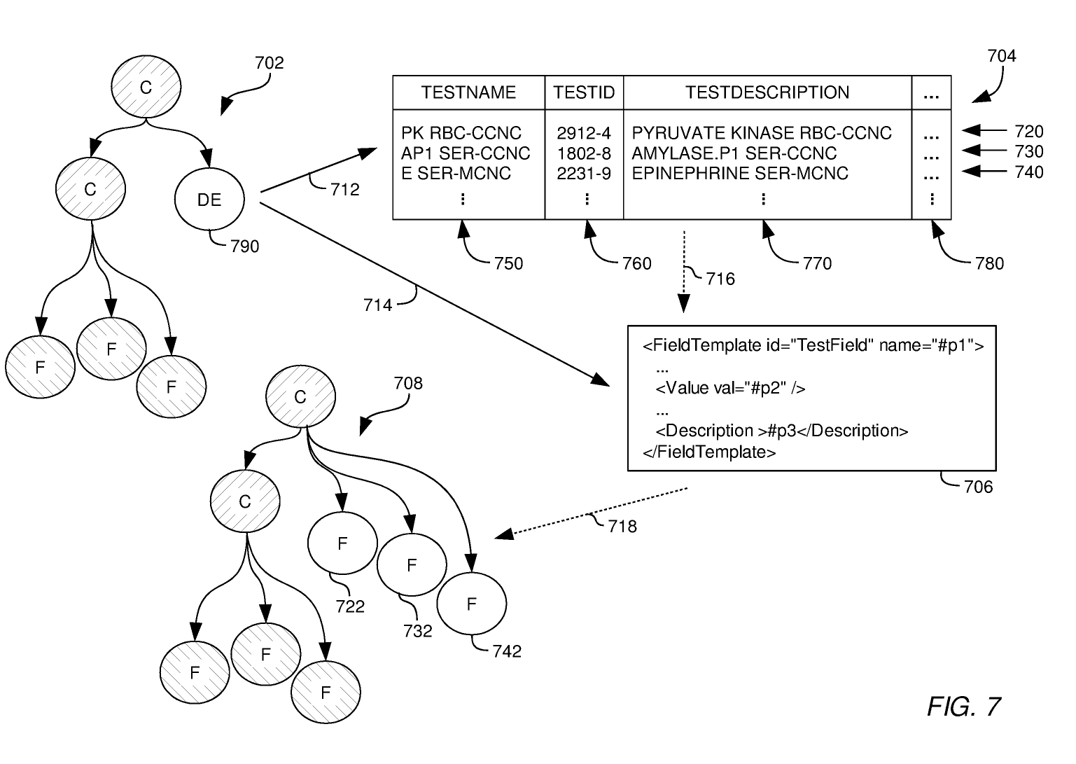

The data abstraction model 292 may also define a dynamic entity 298 configured to generate categories and/or logical fields for the abstraction model 292. In one embodiment, dynamic entity 298 is executed when a user initiates a session for accessing the database 230 using application 240. At that time, dynamic entity 298 may be configured to generate categories and/or logical fields the data abstraction model 292. Further, when data abstraction model 292 includes multiple dynamic entities 298, each one may be executed to generate categories and/or logical fields 294 for the data abstraction model 292. However, if a given dynamic entity attempts to create an existing field category, rather than fail the logical field creation process, then that dynamic entity may be configured to create and store additional logical fields in the existing category. An embodiment of a process for creating categories and/or logical fields using a dynamic entity is described in more detail below with reference to FIGS. 6-7.

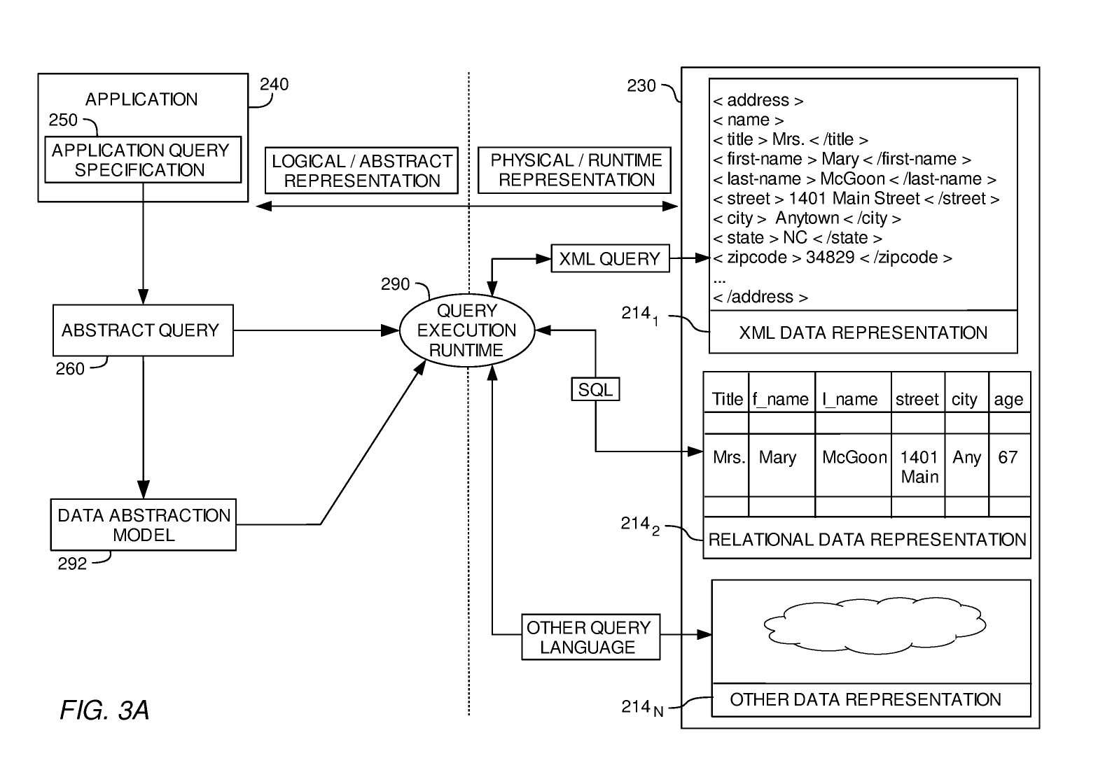

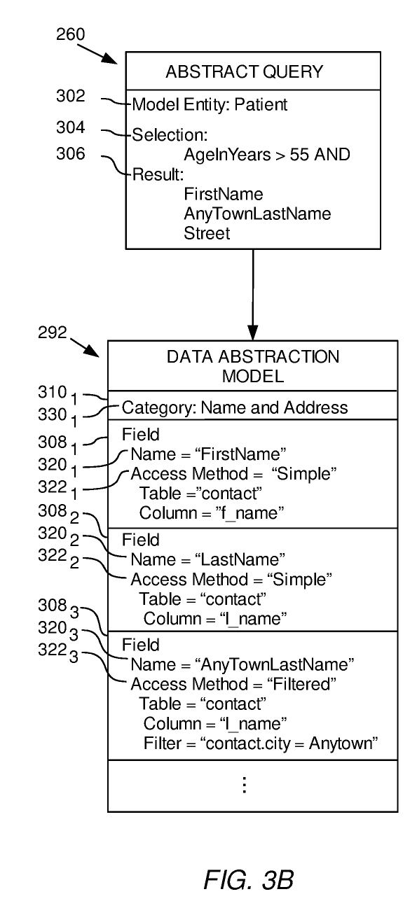

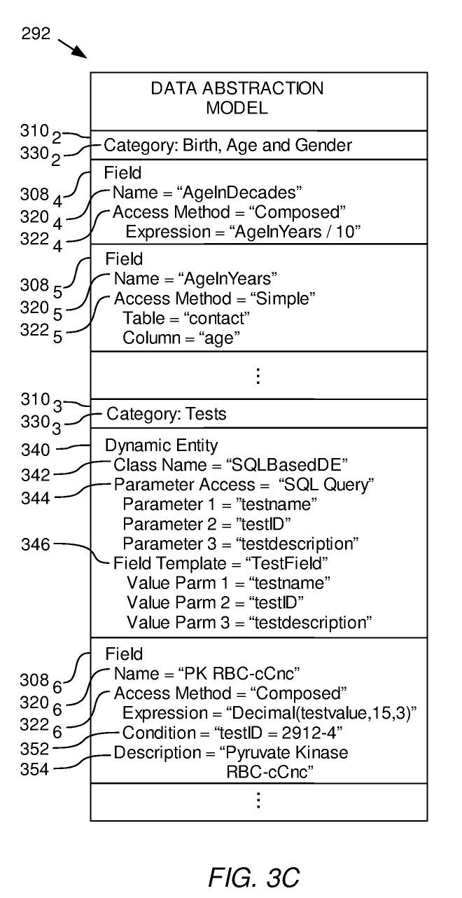

In one embodiment, abstract query 260 may include a query result specification and selection criteria, as explained in more detail below with reference to FIGS. 3A-3C. The result specification may list a set of logical fields for which data values should be returned from the data 232. Abstract query 260 may also include a set of selection criteria specifying one or more logical fields and conditional values used to evaluate whether a given element of data should be returned.

As noted above, in one embodiment, the abstract query 260 is translated into an executable query, such as an SQL or XML query. The executable query is provided to the query execution unit 236. The executable query is then executed by the query execution unit 236 to determine a result set 270 having data values corresponding to the result fields of the abstract query 260.

Note, however, that the query execution unit 236 includes only the query engine 234 for simplicity. However, the query execution unit 236 may include other components, such as a query parser and a query optimizer. A query parser is generally configured to accept a received query input from a requesting entity, such as the application(s) 240, and then parse the received query. The query parser may then forward the parsed query to the query optimizer for optimization. A query optimizer is an application program which is configured to construct a near optimal search strategy (known as an “access plan”) for a given set of search parameters, according to known characteristics of an underlying database (e.g., the database 230), an underlying system on which the search strategy will be executed (e.g., computer system 110 of FIG. 1), and/or optional user specified optimization goals. But not all strategies are equal and various factors may affect the choice of an optimum search strategy. However, in general such search strategies merely determine an optimized use of available hardware/software components to execute respective queries. The query optimizer may then forward the optimized executable query to the query engine 234 for execution. The optimized executable query is then executed by the query engine 234 against the data 232 of the database 230.

### Logical/Runtime View of Environment

FIGS. 3A-3C provide a relational view of software components configured to manage the execution of abstract queries, according to one embodiment of the invention. Illustratively, as shown in FIG. 3A, the components include application 240, data abstraction model 292 and database 230 of FIG. 2, as well as a runtime component 290. By way of example, the database 230 includes a plurality of exemplary physical data representations 214₁, 214₂, . . . 214_{N} for the data 232 of FIG. 2.

As noted above with reference to FIG. 2, the application 240 issues the abstract query 260 against the database 230. In one embodiment, the application 240 issues the query 260 as defined by the application query specification 250. The abstract query 260 is composed from a collection of logical fields (e.g., logical fields 294 of FIG. 2) rather than by direct reference to underlying physical data entities in the database 230. The logical fields are defined by the data abstraction model 292 which generally exposes information as a set of logical fields that may be used within a query (e.g., abstract query 260) issued by the application 240. The query may specify criteria for data selection and the result data that should be returned.

FIG. 3B further illustrates an example of abstract query 260 and data abstraction model 292. As shown, abstract query 260 includes selection criteria 304, in this case a condition of “AgeInYears>55” and an indication of an abstract entity that is the focus for the abstract query 260 (model entity 302), in this case the query is directed to “patients.” Abstract query 260 also includes a result specification 306. Thus, abstract query 260 specifies to identify patients over the age of 55, and for such patients, specifies that data values for the logical fields in result specification 306 should be returned. In one embodiment, the application query specification 250 may include both criteria used for data selection (selection criteria 304) and an explicit specification of the fields to be returned (return data specification 306) based on the selection criteria 304.

The logical fields of the data abstraction model 292 are defined independently of the underlying data representation (i.e., one of the physical data representations 214_{1-N}) being used by database 230, thereby allowing queries to be formed that are loosely coupled to the underlying data representation. More specifically, a logical field defines an abstract view of data whether as an individual data item or a data structure in the form of, for example, a database table. As a result, abstract queries may be defined that are independent of the particular underlying data representation. Such abstract queries can be transformed into a form consistent with the underlying physical data representation 214_{1-N} for execution against the database 230. By way of example, the abstract query 260 is translated by the runtime component 290 into an executable query which is executed against the database 230 to determine a corresponding result set (e.g., result set 270 of FIG. 2) for the abstract query 260.

In one embodiment, illustrated in FIGS. 3B-C, the data abstraction model 292 comprises a plurality of field specifications 308₁, 308₂, 308₃, 308₄, 308₅ and 308₆ (six shown by way of example), collectively referred to as the field specifications 308 (also referred to as “field definitions” or just as “logical fields”). Specifically, a field specification is provided for each logical field available for composing an abstract query. Each field specification may contain one or more attributes. Illustratively, the field specifications 308 include a logical field name attribute 320₁, 320₂, 320₃, 320₄, 320₅, 320₆ (collectively, field name 320) and an associated access method attribute 322₁, 322₂, 322₃, 322₄, 322₅, 322₆ (collectively, access methods 322). Each attribute may have a value. For example, logical field name attribute 320₁ has the value “FirstName” and access method attribute 322₁ has the value “Simple”. Furthermore, each attribute may include one or more associated abstract properties. Each abstract property describes a characteristic of a data structure and has an associated value. In the context of the invention, a data structure refers to a part of the underlying physical representation that is defined by one or more physical entities of the data corresponding to the logical field. In particular, an abstract property may represent data location metadata abstractly describing a location of a physical data entity corresponding to the data structure, like a name of a database table or a name of a column in a database table. Illustratively, the access method attribute 322₁ includes data location metadata “Table” and “Column”. Furthermore, data location metadata “Table” has the value “contact” and data location metadata “Column” has the value “f_name”. Accordingly, assuming an underlying relational database schema in the present example, the values of data location metadata “Table” and “Column” point to a table “contact” having a column “f_name”.

In one embodiment, logical fields may stored using a category structure categories (e.g., category 296 of FIG. 2). Accordingly, data abstraction model 292 also includes a plurality of category specifications 310₁, 310₂ and 310₃ (three shown by way of example), collectively referred to as the category specifications. In one embodiment, a category specification is provided for related groups of logical fields. For example, logical fields 308₁₋₃, 308₄₋₅ and 308₆ are stored in category specifications 310₁, 310₂ and 310₃, respectively. A category specification is also referred to herein simply as a “category”. The categories are distinguished according to a category name, e.g., category names 330₁, 330₂ and 330₃ (collectively, category name(s) 330). In the present illustration, the logical fields 308₁₋₃ are part of the “Name and Address” category, logical fields 308₄₋₅ are part of the “Birth, Age and Gender” category and logical field 308₆ is part of the “Tests” category.

The access methods 322 generally associate (i.e., map) the logical field names to data in the database (e.g., database 230 of FIG. 2). As illustrated in FIG. 3A, the access methods associate the logical field names to a particular physical data representation 214_{1-N} in the database. By way of illustration, two data representations are shown, an XML data representation 214₁ and a relational data representation 214₂. However, the physical data representation 214_{N} indicates that any other data representation, known or unknown, is contemplated. In one embodiment, a single data abstraction model 292 contains field specifications (with associated access methods) for two or more physical data representations 214_{1-N}. In an alternative embodiment, a different single data abstraction model 292 is provided for each separate physical data representation 214_{1-N}.

Any number of access methods is contemplated depending upon the number of different types of logical fields to be supported. In one embodiment, access methods for simple fields, filtered fields and composed fields are provided. The field specifications 308₁, 308₂ and 308₅ exemplify simple field access methods 322₁, 322₂, and 322₅, respectively. Simple fields are mapped directly to a particular entity in the underlying physical representation (e.g., a field mapped to a given database table and column). By way of illustration, as described above, the simple field access method 322₁ shown in FIG. 3B maps the logical field name 320₁ (“FirstName”) to a column named “f_name” in a table named “contact”. The field specification 308₃ exemplifies a filtered field access method 322₃. Filtered fields identify an associated physical entity and provide filters used to define a particular subset of items within the physical representation. An example is provided in FIG. 3B in which the filtered field access method 322₃ maps the logical field name 320₃ (“AnyTownLastName”) to a physical entity in a column named “I_name” in a table named “contact” and defines a filter for individuals in the city of “Anytown”. Another example of a filtered field is a New York ZIP code field that maps to the physical representation of ZIP codes and restricts the data only to those ZIP codes defined for the state of New York. The field specification 308₄ exemplifies a composed field access method 322₄. Composed access methods compute a logical field from one or more physical fields using an expression supplied as part of the access method definition. In this way, information which does not exist in the underlying physical data representation may be computed. In the example illustrated in FIG. 3B the composed field access method 322₄ maps the logical field name 320₄ “AgeInDecades” to “AgeInYears/10”. Another example is a sales tax field that is composed by multiplying a sales price field by a sales tax rate.

It is contemplated that the formats for any given data type (e.g., dates, decimal numbers, etc.) of the underlying data may vary. Accordingly, in one embodiment, the field specifications 308 include a type attribute which reflects the format of the underlying data. However, in another embodiment, the data format of the field specifications 308 is different from the associated underlying physical data, in which case a conversion of the underlying physical data into the format of the logical field is required.

By way of example, the field specifications 308 of the data abstraction model 292 shown in FIG. 3B are representative of logical fields mapped to data represented in the relational data representation 214₂ shown in FIG. 3A. However, other instances of the data abstraction model 292 map logical fields to other physical representations, such as XML.

In one embodiment, the data abstraction model 292 includes one or more dynamic entity definitions (e.g., a dynamic entity 298 of FIG. 2). A dynamic entity definition may specify of a parameterized category, a field template, and a data request, such as an SQL or XML query. The parameterized category and/or field template can be used to generate logical field definitions in the data abstraction model 292 by supplying sets of parameter values. In one embodiment, a data request may be used to retrieve the parameter values from the database 230. Alternatively, a data request could parse a text file and pass each line of text as a separate set of parameters to a template.

A dynamic entity definition may also include a reference to executable code (e.g., a Java® class) or software program configured to generate the corresponding category and/or logical field definitions in the data abstraction model 292 from the template. In one embodiment, the executable code is Java®-based and configured to prevent name conflicts between existing categories and/or logical fields and ones to be created by the template. More specifically, prior to creating, a category and/or logical field using a given set of parameter values, the executable code determines whether one (or both) already exists. If so, the existing category and/or logical field is not generated again by the dynamic entity.

As shown, data abstraction model 292 includes a dynamic entity definition 340. In this example, dynamic entity definition 340 may be executed using a Java® class 342 named “SQLBasedDE.” The dynamic entity 340 also includes a data request specification 344. In this case, an SQL query (Parameter Access=“SQL Query”) is used to retrieve sets of parameter values supplied to a logical field template 346. Specifically, values for the parameters of “testname,” “testID,” and “testdescription” are supplied to template 346 in order to create a logical field. In this example, the “TestField” template defines the pattern for a logical fields generated using the “testname”, “testID” and “testdescription” values (i.e., “Parm 1”, “Parm 2” and “Parm 3”).

As noted above, the logical field and/or category definitions may be generated from a dynamic entity when a database session is initiated. In other words, the logical fields and/or category definitions may be generated prior to displaying the data abstraction model 292 to a user. The logical fields and/or categories generated from a dynamic entity may be displayed to a user in the same manner as other logical fields (e.g., logical fields 308₁₋₃) on user interface 210. For example, the interface 210 may provide a graphical representation of a hierarchal tree structure that corresponds to the categories, sub-categories, and logical fields defined for data abstraction model 292. The categories and/or logical fields can be selected by the user when creating abstract queries, such as abstract query 260.

Assume that the logical field definition 3086 is generated by executing the Java® class “SQLBasedDE.” That is, dynamic entity 340 may be invoked by the runtime component 290 to generate logical fields using template 346. Accordingly, until dynamic entity 340 is invoked, the logical field 3086 does not appear in the data abstraction model 292. By way of example, assume that “PK RBC-cCnc”, “2912-4” and “Pyruvate Kinase RBC-cCnc” were retrieved as a set of parameter values from the database 230 for the template elements of “testname”, “testID” and “testdescription”, respectively. These values were then inserted into the “TestField” template to replace the corresponding placeholders in template 346, whereby the “PK RBC-cCnc” field 3086 was generated. Once generated and stored in the category structure of data abstraction model 292, logical field definition 308₆ can be used together with the field definitions 308₁₋₅ to compose an abstract query.

An illustrative abstract query corresponding to the abstract query 260 shown in FIG. 3B is shown in Table I below. In this example, the query is defined using the XML markup language. However, other markup languages may be used.

TABLE I
ABSTRACT QUERY EXAMPLE

| | |
|---|---|
| 001 | <?xml version=“1.0”?> |
| 002 | <!--Query string representation: (AgeInYears > “55”--> |
| 003 | <QueryAbstraction> |
| 004 | <Selection> |
| 005 | <Condition internalID=“4”> |
| 006 | <Condition field=“AgeInYears” operator=“GT” value=“55” |
| 007 | internalID=“1”/> |
| 008 | </Selection> |
| 009 | <Results> |
| 010 | <Field name=“FirstName”/> |
| 011 | <Field name=“AnyTownLastName”/> |
| 012 | <Field name=“Street”/> |
| 013 | </Results> |
| 014 | <Entity name=“Patient” > |
| 015 | <EntityField required=“Hard” > |
| 016 | <FieldRef name=“data://Demographic/Patient ID” /> |
| 017 | <Usage type=“query” /> |
| 018 | </EntityField> |
| 019 | </Entity> |
| 020 | </QueryAbstraction> |

Illustratively, the abstract query shown in Table I includes a selection specification (lines 004-008) containing selection criteria and a results specification (lines 009-013). In one embodiment, a selection criterion consists of a field name (for a logical field), a comparison operator (=, >, <, etc) and a value expression (what is the field being compared to). In one embodiment, a results specification is a list of abstract fields that are to be returned as a result of query execution. A results specification in the abstract query may consist of a field name and sort criteria. The abstract query shown in Table I further includes a model entity specification in lines 014-019 which specifies that the query is a query of the “patient” model entity.

Table II, below, shows a data abstraction model 292 that corresponds to the FIGS. 3B-C.

TABLE II
DATA ABSTRACTION MODEL EXAMPLE

| | |
|---|---|
| 001 | <?xml version=“1.0”?> |
| 002 | <DataAbstraction> |
| 003 | <Category name=“Name and Address”> |
| 004 | <Field queryable=“Yes” name=“FirstName” displayable=“Yes”> |
| 005 | <AccessMethod> |
| 006 | <Simple columnName=“f_name” tableName=“contact”></Simple> |
| 007 | </AccessMethod> |
| 008 | </Field> |
| 009 | <Field queryable=“Yes” name=“LastName” displayable=“Yes”> |
| 010 | <AccessMethod> |
| 011 | <Simple columnName=“l_name” tableName=“contact”></Simple> |
| 012 | </AccessMethod> |
| 013 | </Field> |
| 014 | <Field queryable=“Yes” name=“AnyTownLastName” displayable=“Yes”> |
| 015 | <AccessMethod> |
| 016 | <Filter columnName=“l_name” tableName=“contact” |
| 017 | Filter=”contact.city=Anytown”> </Filter> |
| 018 | </AccessMethod> |
| 019 | </Field> |
| 020 | </Category> |
| 021 | <Category name=“Birth, Age and Gender”> |
| 022 | <Field queryable=“Yes” name=“AgeInDecades” displayable=“Yes”> |
| 023 | <AccessMethod> |
| 024 | <Composed |
| 025 | Expression=”field:AgeInYears/10”> </Composed> |
| 026 | </AccessMethod> |
| 027 | </Field> |
| 028 | <Field queryable=“Yes” name=“AgeInYears” displayable=“Yes”> |
| 029 | <AccessMethod> |
| 030 | <Simple columnName=“age” tableName=“contact”</Simple> |
| 031 | </AccessMethod> |
| 032 | </Field> |
| 033 | </Category> |
| 034 | <Category name=“Tests”> |
| 035 | <!-- Dynamic entity for numeric tests --> |
| 036 | <DynamicEntity className= “SQLBasedDE”> |
| 037 | <Parm fieldName=“SQLQuery” value=“select distinct |
| 038 | substr(shortname, 1, 32)) as testname, (system) as system, |
| 039 | testID, (descriptions) as descriptions, (component) |
| 040 | concat ‘ ’ concat (system) concat ‘-’ concat (property) as |
| 041 | testdescription from testgroups, tests where class=abbreviation |
| 042 | and length((shortname)) > 0 and testID in (select |
| 043 | distinct test_code from testresults where is_numeric = ‘ ’) |
| 044 | order by descriptions, system, testname” /> |
| 045 | <Parm fieldName=“Field.Template” value=“TestField” /> |
| 046 | <Parm fieldName=“Field.p1” value=“testname” /> |
| 047 | <Parm fieldName=“Field.p2” value=“testID” /> |
| 048 | <Parm fieldName=“Field.p3” value=“testdescription” /> |
| 049 | </DynamicEntity> |
| 050 | <!-- Dynamic entity for enumerated list tests --> |
| 051 | <DynamicEntity className= “SQLBasedDynamicEntity”> |
| 052 | <Parm fieldName=“SQLQuery” value=“select distinct |
| 053 | (substr(shortname, 1, 32)) as testname, (system) as system, |
| 054 | testID, (descriptions) as descriptions, (component) concat ‘ ’ |
| 055 | concat (system) concat ‘-’ concat (property) as testdescription |
| 056 | from testgroups, tests where class=abbreviation and |
| 057 | length((shortname)) > 0 and testID in (select distinct |
| 058 | test_code from testresults where is_numeric = ‘L’) order by |
| 059 | descriptions, system, testname” /> |
| 060 | <Parm fieldName=“Category.1.Template” value=“TestCategory” /> |
| 061 | <Parm fieldName=“Category.1.p1” value=“descriptions” /> |
| 062 | <Parm fieldName=“Category.2.Template” value=“System” /> |
| 063 | <Parm fieldName=“Category.2.p1” value=“system” /> |
| 064 | <Parm fieldName=“Field.Template” value=“TestFieldList” /> |
| 065 | <Parm fieldName=“Field.p1” value=“testname” /> |
| 066 | <Parm fieldName=“Field.p2” value=“testID” /> |
| 067 | <Parm fieldName=“Field.p3” value=“testdescription” /> |
| 068 | </DynamicEntity> |
| 069 | <Attribute name=“Age” type=“EventCondition” > |
| 070 | <FieldRef name=“field:AgeInYears” /> |
| 071 | </Attribute> |
| 072 | <Description >Patient test results</Description> |
| 073 | <Field name=“PK RBC-cCnc” rangeCapable=“Yes” > |
| 074 | <AccessMethod > |
| 075 | <Composed > |
| 076 | <Composition > |
| 077 | DECIMAL(<FieldRef name=“data://db/TestValue” />, 15, 3) |
| 078 | </Composition> |
| 079 | <Where > |
| 080 | <Condition field=“data://db/TestType” operator=“EQ” > |
| 081 | <Value val=“2912-4” /> |
| 082 | </Condition> |
| 083 | </Where> |
| 084 | </Composed> |
| 085 | </AccessMethod> |
| 086 | <Type baseType=“float” > |
| 087 | <Range maxValue=“100000.0” minValue=“0.0” /> |
| 088 | </Type> |
| 089 | <Description >Pyruvate Kinase RBC-cCnc</Description> |
| 090 | <Attribute name=“ULN” type=“NamedValue” > |
| 091 | <FieldRef name=“data://db/ULNField” /> |
| 092 | </Attribute> |
| 093 | <Attribute name=“LLN” type=“Named Value” > |
| 094 | <FieldRef name=“data://db/LLNField” /> |
| 095 | </Attribute> |
| 096 | </Field> |
| 097 | </Category> |
| 098 | </DataAbstraction> |

In this example, lines 004-008 correspond to the first field specification 308₁ of the DAM 292 shown in FIG. 3B and lines 009-013 correspond to the second field specification 308₂. Lines 036-049 correspond to dynamic entity definition 340 of the data abstraction model 292 shown in FIG. 3C. More specifically, line 036 identifies the “SQLBasedDE” Java® class used to execute the dynamic entity. Lines 037-044 identify the data request 344 (in this case an SQL query) used to retrieve sets of parameter values to supply to field template 346. Line 045 represents the specific template to use as denoted by the name “Field.Template”. Lines 046-048 represent the parameter value mappings to values in the data table.

Table II also illustrates a second example of a dynamic entity definition at lines 051-068. By using multiple dynamic entities, groups of logical fields that have different patterns may be generated. For instance, the dynamic entity defined in lines 036-049 is configured to generate logical fields related to tests that return numeric result values. In contrast, the dynamic entity defined in lines 051-068 is configured to generate logical fields related to tests that return character based result values, such as “positive,” “negative,” “present,” “absent,” “yes,” or “no.” Populating a data abstraction model having one or more dynamic entities is described in more detail below with reference to FIG. 6.

Embodiments of the invention allow both dynamic entities to create and store logical fields in the categories of a data abstraction model, without having to create an artificial category structure in order to avoid name collisions between categories and fields. Instead, when the dynamic entities shown in lines 036-049and 051-068 are executed, prior to creating a category and/or logical field, a determination is made whether such field or category already exist within data abstraction model 292. If neither the category nor the field exists, both are created using the field template specified by the dynamic entity. Otherwise, if the category already exists, a logical field may be generated within the already existing category. If neither the category nor the field exists, both are created using the field template specified by the dynamic entity. Otherwise, if the category already exists, a logical field may be generated within the already existing category

### Generating an Executable Query from an Abstract Query

As noted above, an executable query may be generated from the abstract query of Table I and executed against an underlying database (e.g., database 230 of FIG. 3A). An exemplary method for generating an executable query on the basis of an abstract query is described below with reference to FIGS. 4-5.

FIG. 4 is a flow diagram of a method 400 for generating an executable query from an abstract query (e.g., abstract query 260 of FIG. 2), according to one embodiment of the invention. Method 400 may be performed by the runtime component 290 of FIG. 3A. As shown, method 400 begins at step 402, where runtime component 290 receives the abstract query (such as the abstract query shown in Table I). At step 404, the runtime component 290 reads and parses the abstract query and locates individual selection criteria (e.g., selection criteria 304 of FIG. 3B) and desired result fields (e.g., return data specification 306 of FIG. 3B).

At step 406, the runtime component 290 enters a loop (defined by steps 406, 408, 410 and 412) for processing each query selection criteria statement present in the abstract query, thereby building a data selection portion of a concrete query. In one embodiment, a selection criterion consists of a field name (for a logical field), a comparison operator (=, >, <, etc) and a value expression (what is the field being compared to). At step 408, the runtime component 290 uses the field name from a selection criterion of the abstract query to look up the definition of the field in the data abstraction model 292. As noted above, the field definition includes a definition of the access method used to access the data structure associated with the field. The runtime component 290 then builds (step 410) a concrete query contribution for the logical field being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the database 230 shown in FIG. 2. The concrete query contribution generated for the current field is then added to a concrete query statement (step 412). The method 400 then returns to step 406 to begin processing for the next field of the abstract query. Accordingly, the process entered at step 406 is iterated for each data selection field in the abstract query, thereby contributing additional content to the eventual query to be performed.

After building the data selection portion of the concrete query, the runtime component 290 identifies the information to be returned as a result of query execution. As described above, in one embodiment, the abstract query defines a list of result fields, i.e., a list of logical fields that are to be returned as a result of query execution, referred to herein as a results specification. A results specification in the abstract query may consist of a field name and sort criteria. Accordingly, the method 400 enters a loop at step 414 (defined by steps 414, 416, 418 and 420) to add result field definitions to the concrete query being generated. At step 416, the runtime component 290 looks up a result field name (from the result specification of the abstract query) in the data abstraction model 292 and then retrieves a result field definition from the data abstraction model 292 to identify the physical location of data to be returned for the current logical result field. The runtime component 290 then builds (at step 418) a concrete query contribution (of the concrete query that identifies physical location of data to be returned) for the logical result field. At step 420, the concrete query contribution is then added to the concrete query statement. Once each of the result specifications in the abstract query has been processed, processing continues at step 422, where the concrete query is executed.

One embodiment of a method 500 for building a concrete query contribution for a logical field according to steps 410 and 418 is described with reference to FIG. 5. At step 502, the method 500 queries whether the access method associated with the current logical field is a simple access method. If so, the concrete query contribution is built (step 504) based on physical data location information and processing then continues according to method 400 as described above. Otherwise, processing continues to step 506 to query whether the access method associated with the current logical field is a filtered access method. If so, the concrete query contribution is built (step 508) based on physical data location information for a given data structure(s). At step 510, the concrete query contribution is extended with additional logic (filter selection) used to subset data associated with the given data structure(s). Processing then continues according to method 400 described above.

If the access method is not a filtered access method, processing proceeds from step 506 to step 512 where the method 500 queries whether the access method is a composed access method. If the access method is a composed access method, the physical data location for each sub-field reference in the composed field expression is located and retrieved at step 514. At step 516, the physical field location information of the composed field expression is substituted for the logical field references of the composed field expression, whereby the concrete query contribution is generated. Processing then continues according to method 400 described above.

If the access method is not a composed access method, processing proceeds from step 512 to step 518. Step 518 is representative of any other access method types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

### Managing Logical Field and Category Creation Using Dynamic Entities

FIG. 6 is a flow diagram illustrating a method 600 for generating a collection of logical fields using a dynamic entity (e.g., dynamic entity 298 of FIG. 2), according to one embodiment of the invention. Each dynamic entity may be defined by a corresponding dynamic entity definition in a data abstraction model (e.g., data abstraction model 292 of FIG. 3C). In one embodiment, at least some of the steps of method 600 may be performed using the runtime component 290 of FIG. 3A.

Method 600 begins at step 610, where a dynamic entity definition (e.g., dynamic entity definition 340 of FIG. 3C) is retrieved from an underlying data abstraction model. By way of example, assume that the exemplary dynamic entity definition in lines 036-049 of Table II is retrieved from the exemplary data abstraction model of Table II.

At step 620, a data request (e.g., data request 344 of FIG. 3C) associated with the dynamic entity definition is identified. The data request is executed against a database (e.g., database 230 of FIG. 3A) to retrieve one or more sets of parameter values to supply to the dynamic entity. In the given example, the SQL query defined in lines 037-044 of Table II is identified and executed against a database having “testgroups”, “tests” and “testresults” tables (lines 041 and 043 of Table II).

In one embodiment, a temporary data structure is generated from the retrieved sets of parameter values. The temporary data structure may be discarded when processing of the retrieved dynamic entity definition is complete. The temporary data structure may be created as a table where each row defines a set of parameter values for the dynamic entity. Table III below shows an example generated for dynamic entity 340.

TABLE III
PARAMETER VALUE TABLE EXAMPLE

| 001 | testname | system | testID | descriptions | testdescription |
|---|---|---|---|---|---|
| 002 | PK RBC-cCnc | RBC | 2912-4 | Chemistry | Pyruvate Kinase RBC-cCnc |
| 003 | AP1 SER-cCnc | SER | 1802-8 | Chemistry | Amylase.P1 SER-cCnc |
| 004 | E SER-mCnc | SER | 2231-9 | Chemistry | Epinephrine SER-mCnc |

The rows of Table III include three different sets of parameter values, one set in each of lines 002-004, having information related to three different blood tests. More specifically, each row of Table III includes testname, system, testID, descriptions and testdescription values for different blood tests. For example, the example test names are “Pyruvate Kinase RBC-cCnc” (line 002), “Amylase.P1 SER-cCnc” (line 003) and “Epinephrine SER-mCnc” (line 004).

At step 630, a category hierarchy is identified from the dynamic entity definition. In the given example, the dynamic entity definition does not define a required category hierarchy, but is instead included with the “Tests” category (line 034 of Table II). Accordingly, the sets of parameter values of Table III are used to create logical fields in the root “Tests” category of the data abstraction model.

In other cases, however, a dynamic entity definition may define a category hierarchy for the logical fields generated for that category. That is, a given dynamic entity definition may include a category specification indication a location in the underlying data abstraction model category structure where the corresponding logical fields should be stored. The category specification can be static (i.e., indicating a particular category name and location) or parameterized (i.e., referring to a parameterized category template). Table II, above, illustrates a parameterized category specification in lines 060-063 of the second dynamic entity definition listed in lines 051-068. Illustratively, the parameterized category specification refers to an underlying category template of “TestCategory” (line 060 of Table II) and a “System” template (line 062 of Table II). When the dynamic entity defined in lines 051-068 of Table II is executed, a first subcategory is created in the “Tests” category (line 034 of Table II) using the “TestCategory” template and a second subcategory is created in the first subcategory using the “System” template.

At step 640, the runtime component 290 determines whether the category hierarchy specified by the dynamic entity already exists within the data abstraction model. If so, processing proceeds with step 660. Otherwise, the category hierarchy specified by the dynamic entity is created at step 650. For example, based on the category definitions at lines 060-063 of Table II, a “chemistry” subcategory is created beneath the “testcategory” (lines 060-061) and second-level sub categories are created for the “RBC” and “SER” values in the “system” column (lines 062-063) or the At step 660, a loop that includes steps 660-680 is entered for each retrieved set of parameter values. Assume, for example, that the loop of 660-680 is performed for the set of parameter values in line 002 of the exemplary value table of Table III. Initially entering the loop of steps 660-680 includes retrieving a parameterized field template from the underlying dynamic entity definition. In the given example, the underlying dynamic entity definition refers to a “TestField” template (line 045 of Table II). Table IV, below, provides an example “TestField” template composed in XML.

TABLE IV
TESTFIELD TEMPLATE EXAMPLE

| | |
|---|---|
| 001 | <FieldTemplate id=”TestField” name=“#p1” |
| | rangeCapable=“Yes” > |
| 002 | <AccessMethod > |
| 003 | <Composed > |
| 004 | <Composition > |
| 005 | DECIMAL(<FieldRef name=“data://db/TestValue” />, |
| | 15, 3) |
| 006 | </Composition> |
| 007 | <Where > |
| 008 | <Condition field=“data://db/TestType” |
| | operator=“EQ” > |
| 009 | <Value val=“#p2” /> |
| 010 | </Condition> |
| 011 | </Where> |
| 012 | </Composed> |
| 013 | </AccessMethod> |
| 014 | <Type baseType=“float” > |
| 015 | <Range maxValue=“100000.0” minValue=“0.0” /> |
| 016 | </Type> |
| 017 | <Description >#p3</Description> |
| 018 | <Attribute name=“ULN” type=“NamedValue” > |
| 019 | <FieldRef name=“data://db/ULNField” /> |
| 020 | </Attribute> |
| 021 | <Attribute name=“LLN” type=“NamedValue” > |
| 022 | <FieldRef name=“data://db/LLNField” /> |
| 023 | </Attribute> |
| 024 | </FieldTemplate> |

Illustratively, the field template shown in Table IV is configured to generate numeric test fields, i.e., logical fields that are related to numeric values (lines 005 and 014-016). The field template also includes three placeholders for parameter values in lines 001, 009 and 017 (“#p1”, “#p2”, and “#p3”, respectively). Using the field template specification in the dynamic entity definition (lines 046-048 of Table II), the “#p1” placeholder is replaced by “testname” values (line 0046 of Table II), the “#p2” placeholder with “testID” values (line 047 of Table II) and the “#p3” placeholder with “testdescription” values (line 048 of Table II) in order to generate a logical field from the template and the values listed in line 002 of Table III.

Additionally, the template definition shown in Table IV specifies an allowed data type and value range in lines 014-016. Similarly, the template definition also includes two attributes defining an upper limit of normal and a lower limit of normal in lines 018-023. These attributes are part of the pattern common for all logical fields generated using this template. Of course, these attributes and parameters are shown for purposes of illustration, and the attributes and parameters needed for a particular case will vary from the ones shown in Table IV.

At step 670, it is determined whether a logical field corresponding to the set of parameter values is present in the underlying data abstraction model for which logical fields are being created. In other words, if a logical field corresponding to the logical field template and a particular set of parameter values is already present, the field is not recreated. And instead, processing returns to step 660, where the loop of steps 660-680 is entered for another set of parameter values. Otherwise, processing continues at step 680.

At step 680, the logical field corresponding to the set of parameter values is generated. The logical field is inserted into the corresponding category in the underlying data abstraction model. In the given example, the placeholders in lines 001, 009 and 017 of the field template of Table IV (i.e., “#p1 ”, “#p2”, and “#p3”, respectively) are replaced with the values “PK RBC-cCnc”, “2912-4” and “Pyruvate Kinase RBC-cCnc”, respectively. The resulting logical field specification is inserted into the “Tests” category of the exemplary data abstraction model of Table II. Accordingly, the logical field defined in lines 073-096 of the exemplary data abstraction model of Table II is created.

Processing then returns to step 660, where the loop of steps 660-680 is repeated for another set of parameter values. In the given example, the loop is repeated using the set of parameter values in line 003 of Table III.

Once each set of parameter values is processed, processing exits. In the given example, processing exits after creating of three logical fields from the three sets of parameter values in lines 002-004 of Table III. Specifically, the logical fields “PK RBC-cCnc” (line 002 of Table III), “AP1 SER-cCnc” (line 003 of Table III) and “E SER-mCnc” (line 004 of Table II) are created.

In the given example, a second dynamic entity is defined in lines 051-068 of the exemplary data abstraction model of Table II. Accordingly, the method 600 may be performed using the second dynamic entity to generate additional logical fields stored in the data abstraction model. Importantly, however, as was noted above, existing categories and/or logical fields that were created on the basis of the first dynamic entity in lines 036-049 of Table II as described above are not overwritten and/or re-created.

FIG. 7 is a conceptual illustration of a data abstraction model 702 (e.g., data abstraction model 292 of FIGS. 3B-3C) and a dynamic entity 790 (e.g., dynamic entity definition 340 of FIG. 3C) used to create a set of logical fields, according to one embodiment of the invention. By way of example, the data abstraction model 702 is illustrated as a tree structure having categories (“C”) and logical fields (“F”) as well as the dynamic entity 790 (“DE”).

As illustrated by an arrow 712, sets of parameter values are retrieved and stored in a temporary value table 704 (e.g., Table III). The temporary value table 704 includes a “testname” column 750, a “testID” column 760 and a “testdescription” column 770. The table 704 further includes a column 780 illustrating that various other columns could be generated. Such columns may include information that is not used by dynamic entity 790. However, in one embodiment, a single temporary data structure may be created for executing a plurality of dynamic entities. In such a case, the single temporary data structure stores all of the information that is needed by each separate dynamic entity.

Illustratively, table 704 has three rows 720, 730, and 740. Each row includes a separate set of parameter values used to generate a particular logical field. By way of example, the sets of parameter values 720-740 match the parameter values in lines 002-004 of Table III. As illustrated by an arrow 714, a parameterized field template 706 (e.g., the field template of Table IV) is associated with the dynamic entity 790. When executed, the dynamic entity 790 retrieves field template 706 and uses it to generate logical fields 722732 and 742. That is, by replacing placeholders in the field template 706 with the sets of parameter values in rows 720-740 of the value table 704 (indicated by a dashed arrow 716) three logical fields 722, 732, 742 are generated (indicated by an arrow 718). The generated logical fields 722, 732, and 742 are inserted into the corresponding categories of the data abstraction model 702. Additional dynamic entities may be processed similarly.

Additionally, in one embodiment, when each dynamic entity of the data abstraction model 702 is executed, the logical fields created by the dynamic entities may be ordered according to sorting criteria specified by the data abstraction model. In the illustrated example, the logical fields 722, 732, 742 are sorted alphabetically (within each category) before being displayed to a user. Thus, retrieving of a particular logical field in the modified data abstraction model 708 is simplified for the user.

Embodiments of the invention allow multiple dynamic entities to be used to create and store logical fields in the categories of a data abstraction model, without having to create an artificial category structure in order to avoid name collisions between categories and fields. Advantageously, in the event that a particular dynamic entity specifies to generate a logical field and/or category that already exists within the data abstraction model, that dynamic entity may be configured to create and store additional logical fields in the existing category. Thus, attempts to re-create an existing category or field may effectively be ignored to prevent errors which might otherwise result in process interruption and/or program abort.

While the foregoing is directed to embodiments of the present invention, other and further embodiments of the invention may be devised without departing from the basic scope thereof, and the scope thereof is determined by the claims that follow.

What is claimed is:

1. A computer-implemented method of generating logical fields for a data abstraction model, comprising:
retrieving, from the data abstraction model, a dynamic entity definition that identifies a logical field template used to generate a group logical fields;
retrieving one or more sets of parameter values, wherein each set of parameter values may be supplied to the template in order to create a logical field;
determining, for a first set of parameter values, whether a logical field to be generated from the logical field template and the first set of parameter values is present in the data abstraction model; and
upon determining that the logical field to be generated from the logical field and the first set of parameter values is not present in the data abstraction model,
generating the logical field from the logical field template and the first set of parameter values, and
adding the generated logical field to the data abstraction model.

2. The method of claim 1, wherein retrieving one or more sets of parameter values, comprises:
retrieving a data request from the dynamic entity definition;
executing the data request to retrieve the one or more sets of parameter values; and
generating a temporary data structure to store the one or more sets of parameter values.

3. The method of claim 2, wherein the temporary data structure is generated in tabular form having a multiplicity of rows, each containing one of the sets of parameters.

4. The method of claim 2, wherein the data request comprises one or more SQL queries.

5. The method of claim 1, wherein the data abstraction model stores logical fields in a plurality of logical field categories, and wherein determining, for a first set of parameter values, whether a logical field to be generated from the logical field template and the first set of parameter values is present in the data abstraction model comprises determining whether the logical field to be generated is present in a category specified for the logical field to be generated.

6. The method of claim 5, wherein the plurality of logical field categories are organized using a hierarchical category structure.

7. The method of claim 1, wherein the dynamic entity definition specifies a logical field category to be created in the data abstraction model, wherein at least one of the logical fields generated from the template are stored in the category to be created.

8. The method of claim 1, wherein the data abstraction model includes a first dynamic entity that is associated with a first logical field template and a second dynamic entity that is associated with a second logical field template; and wherein retrieving the one or more parameters from the database comprises:
generating a first temporary data structure having sets of parameters values for the first dynamic entity; and
generating a second temporary data having sets of parameter values for the second dynamic entity.

9. A computer-readable storage medium containing a program which, when executed by a processor, performs a process for generating logical fields for a data abstraction model, the process comprising;
retrieving, from the data abstraction model, a dynamic entity definition that identifies a logical field template used to generate a group logical fields;
retrieving one or more sets of parameter values, wherein each set of parameter values may be supplied to the template in order to create a logical field;
determining, for a first set of parameter values, whether a logical field to be generated from the logical field template and the first set of parameter values is present in the data abstraction model; and
upon determining that the logical field to be generated from the logical field and the first set of parameter values is not present in the data abstraction model,
generating the logical field from the logical field template and the first set of parameter values, and
adding the generated logical field to the data abstraction model.

10. The computer-readable storage medium of claim 8, wherein retrieving one or more sets of parameter values, comprises:
retrieving a data request from the dynamic entity definition;
executing the data request to retrieve the one or more sets of parameter values; and
generating a temporary data structure to store the one or more sets of parameter values.

11. The computer-readable storage medium of claim 10, wherein the temporary data structure is generated in tabular form having a multiplicity of rows, each containing one of the sets of parameters.

12. The computer-readable storage medium of claim 10, wherein the data request comprises one or more SQL queries.

13. The computer-readable storage medium of claim 9, wherein the data abstraction model stores logical fields in a plurality of logical field categories, and wherein determining, for a first set of parameter values, whether a logical field to be generated from the logical field template and the first set of parameter values is present in the data abstraction model comprises determining whether the logical field to be generated is present in a category specified for the logical field to be generated.

14. The computer-readable storage medium of claim 13, wherein the plurality of logical field categories are hierarchical.

15. The computer-readable storage medium of claim 9, wherein the dynamic entity definition specifies a logical field category to be created in the data abstraction model, wherein at least one of the logical fields generated from the template are included in the category to be created.

16. The computer-readable storage medium of claim 9, wherein the data abstraction model includes a first dynamic entity that is associated with a first logical field template and a second dynamic entity that is associated with a second logical field template; and wherein retrieving the one or more parameters from the database comprises:
generating a first temporary data structure having sets of parameters values for the first dynamic entity; and
generating a second temporary data having sets of parameter values for the second dynamic entity.

17. A system, comprising:
a processor; and
a memory containing a program which, when executed by the processor, is configured to:
retrieve, from the data abstraction model, a dynamic entity definition that identifies a logical field template used to generate a group logical fields;
retrieve one or more sets of parameter values, wherein each set of parameter values may be supplied to the template in order to create a logical field;
determine, for a first set of parameter values, whether a logical field to be generated from the logical field template and the first set of parameter values is present in the data abstraction model; and
upon determining that the logical field to be generated from the logical field and the first set of parameter values is not present in the data abstraction model,
generate the logical field from the logical field template and the first set of parameter values, and
add the generated logical field to the data abstraction model.

18. The system of claim 17, wherein the program is configured to retrieve one or more sets of parameter values by:
retrieving a data request from the dynamic entity definition;
executing the data request to retrieve the one or more sets of parameter values; and
generating a temporary data structure to store the one or more sets of parameter values.

19. The system of claim 18, wherein the data request comprises one or more SQL queries.

20. The system of claim 17, wherein the data abstraction model stores logical fields in a plurality of logical field categories, and wherein the program is configured to determine, for a first set of parameter values, whether a logical field to be generated from the logical field template and the first set of parameter values is present in the data abstraction model by determining whether the logical field to be generated is present in a category specified for the logical field.

21. The system of claim 17, wherein the dynamic entity definition specifies a logical field category to be created in the data abstraction model, wherein at least one of the logical fields generated from the template are included in the category to be created.

22. The system of claim 17, wherein the data abstraction model includes a first dynamic entity that is associated with a first logical field template and a second dynamic entity that is associated with a second logical field template; and wherein the program is configured to retrieve one or more sets of parameter values by:
generating a first temporary data structure having sets of parameters values for the first dynamic entity; and
generating a second temporary data having sets of parameter values for the second dynamic entity.
